(19) United States
(12) Patent Application Publication
(10) Pub. No.: US 2021/0082075 A1
(43) Pub. Date: Mar. 18, 2021

(54) SYSTEMS AND METHODS FOR MATCHING TRANSPORTATION DEVICES BASED ON CONVERSION PROBABILITY

(71) Applicant: Lyft, Inc., San Francisco, CA (US)

(72) Inventors: Charles Parker Spielman, San Francisco, CA (US); Mayank Gulati, San Francisco, CA (US); Guy-Baptiste Richard de Capele d'Hautpoul, San Francisco, CA (US); Krishna Kumar Selvam, San Francisco, CA (US); Aleksandr Zamoshchin, San Francisco, CA (US)

(21) Appl. No.: 16/718,129

(22) Filed: Dec. 17, 2019

Related U.S. Application Data
(60) Provisional application No. 62/900,528, filed on Sep. 14, 2019.

(51) Int. Cl. G06Q 50/30; G06Q 30/06

(52) U.S. Cl. CPC G06Q 50/30; G06N 5/04; G06Q 30/0629

(57) ABSTRACT

The disclosed computer-implemented method may include implementing factors and conversion probabilities when matching a transportation requestor to a transportation provider. Matches between transportation requestors and transportation providers that rely solely on an estimation of arrival time may not give requestors or providers the best transportation options. Lacking these optimal transportation options, requestors and providers may move to other platforms. By looking at a various transportation factors and conversion probabilities, the method may provide optimal transportation options to both requestors and providers. Various other methods, systems, and computer-readable media are also disclosed.

### CROSS REFERENCE TO RELATED APPLICATION

This application claims the benefit of U.S. Provisional Application No. 62/900,528, filed 14 Sep. 2019, the disclosure of which is incorporated, in its entirety, by this reference. This application relates to co-pending applications Ser. Nos. [TBD] and [TBD], filed on same day herewith, the disclosures of which are incorporated, in their entirety, by this reference.

### BACKGROUND

A dynamic transportation matching service may match individuals and groups who request transportation from a starting point to a destination with transportation providers that are associated with a dynamic transportation network managed by the dynamic transportation matching system. In some cases, the dynamic transportation matching system may determine a match between a transportation requestor and a transportation provider based on a single factor such as estimated time of arrival (ETA) or based on cost to the requestor. For example, the dynamic transportation matching system may look at multiple providers in the requestor's general area and may determine which provider has the shortest ETA to the individual. Or, the dynamic transportation matching system may look at multiple providers in the individual's general area and may select the provider that can provide the requested transportation at the lowest cost.

Factors such as cost and ETA, however, are measured in dollars and minutes. Other factors may be measured in percentages, whole numbers, fractions, or other units. As such, it may be difficult to compare more than one factor when determining a match for a requestor and a transportation provider. Accordingly, the instant disclosure identifies and addresses a need for additional and improved systems and methods for matching transportation requestors and providers based on factors other than or in addition to ETA or cost.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an example scenario involving a transportation requestor and multiple possible transportation providers.

FIG. 2 is an illustration of an example architecture for matching requestors and providers based at least in part on a combination of transportation factors.

FIG. 3 is an illustration of an example architecture in which multiple different transportation factors are normalized into commensurable, normalized values.

FIG. 4 is an illustration of an alternate example scenario involving a transportation requestor and multiple possible transportation providers.

FIG. 5 is an illustration of an example architecture in which multiple different transportation factors are weighted and in which the weighted values are implemented to determine an expected value metric.

FIG. 6 is an illustration of an alternate example scenario involving a transportation requestor and multiple possible transportation providers.

FIG. 7 is an illustration of an example architecture in which multiple different transportation subfactors are accessed to form a transportation conversion factor.

FIG. 8 is an illustration is an illustration of an example architecture in which expected value metrics are recalculated in light of incoming information.

FIG. 9 is a block diagram of an example system for immediate matching of requestor devices to provider devices.

FIG. 10 is a flow diagram of an example method for matching of requestor devices to provider devices based on expected value.

FIG. 11 is an illustration of an example requestor/provider management environment.

FIG. 12 is an illustration of an example data collection and application management system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to systems and methods for generating and implementing an expected value metric when matching transportation providers and requestors. Many traditional transportation matching systems look at a single factor, such as cost or ETA, when matching transportation providers and requestors. Looking solely at a single factor, however, may result in matches between transportation providers and requestors that are less than optimal. For example, some transportation providers and some transportation requestors may have preferences regarding location, time to pickup, cost to the provider or to the requestor, or other preferences. If a matching decision is based on a single factor, that match may not consider all of the requestor and providers' preferences and may further fail to consider the impact a single match may have on the overall transportation matching system. In contrast, the systems described herein may make improved matches when comparing multiple factors to make a matching decision, even if those factors include different types of measurement units.

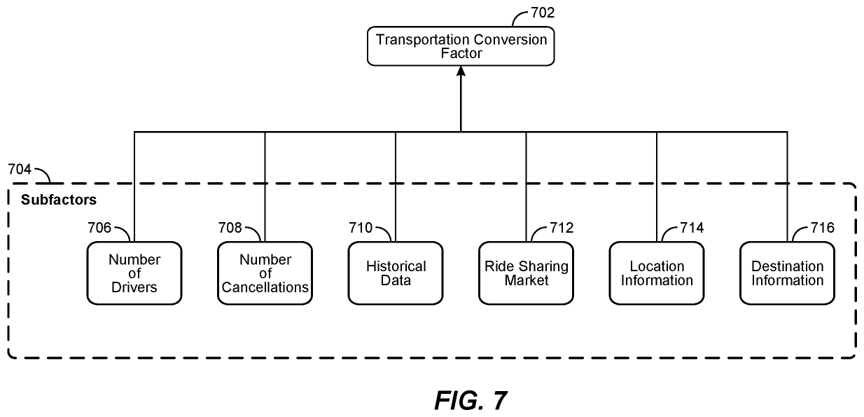

Different factors, for example, may use different units of measurement. An ETA factor, for instance, may be measured in time. The ETA may indicate the amount of time before the transportation provider will arrive at the requestor's location. Or, in some cases, the ETA may indicate the amount of total time needed to take the transportation requestor from their current location to their requested destination. In either case, the ETA factor is measured in time (e.g., minutes, hours, etc.). Another type of factor, referred to as a “conversion factor,” may be measured in discrete numbers (e.g., on a scale from 1-10) or in percentages, or in some other units. The conversion factor may indicate the likelihood that, for a given transportation option, the matched transportation provider and requestor will each accept the proposed transportation, with the transportation provider picking the requestor up and taking them to their destination without the requestor cancelling the trip. The conversion factor may be based on many different subfactors (as will be explained in greater detail below with regard to FIG. 7), but regardless of how the conversion factor is computed, it will most likely be measured in units that are different than time. Similarly, a cost factor representing the calculated cost of the transportation (generated, for example, based on current supply and demand, match efficiency, etc.) may be measured in dollars, euros, yen, or other currency, but will most likely not be measured in time or percentages. Many other factors will be described further below, and each may be considered when determining an expected value metric for a trip. These factors, however, may each have different units of measurement such as time, money, percentages, scale units, or other units of measuring. At least some of these measuring units may be, at least initially, incommensurable.

As used herein, the term “commensurable” may refer to measuring units or items that are measurable using a common measurement standard, a common scale, and/or a common value type. The term “incommensurable,” as used herein, may refer to units or items that are not measurable using the same standard, scale, and/or common value type. For example, as noted above, an ETA factor may be measured in units of time (e.g., hours, minutes, seconds, etc.). Other factors may be measured using other types of measurement units such as conversion percentages or cost-related currency values. These factors' native measurement units may thus be disparate in nature and may not be capable of being directly compared on a common scale. If the measurement units of a given factor (e.g., ETA) do not align with or are not measured in the same way as another factor (e.g., cost), the measurement units may be said to be incommensurable with each other. As will be described in greater detail below, the embodiments described herein may implement a normalizing function that normalizes the measurement units and renders those units commensurable with each other. These normalized measurement units are commensurable in that the normalized measurement units align with each other or are measurable using the same common standard. Accordingly, factors whose measurement units have been normalized using the normalization function are commensurable and may be compared with each other using a common measurement standard, a common scale, or a common value type. In this manner, the normalizing function may take factors and measurement units that are initially incommensurable and render them commensurable with each other.

Once the various factors can be compared with each other in a uniform, standardized manner for any given transportation option, the factors may be considered together as a group to identify an overall expected value metric. The term “expected value,” as used herein, may refer to an overall value to a transportation matching system of a providing a specific transportation option (e.g., the overall value of matching a certain transportation provider with a certain requestor). The expected value metric may indicate the overall amount of merit, advantage, positivity, or desirability of matching a given transportation provider with a given requestor. The expected value metric may be calculated based on any number of factors or subfactors and may be different for each transportation provider, for each transportation requestor, and for each situation. Thus, the expected value metric may represent the expected value to the transportation provider, to the transportation requestor, and/or to the dynamic transportation network.

As will be explained in greater detail below, a dynamic transportation matching system may arrange transportation on an on-demand and/or ad-hoc basis by, e.g., matching one or more transportation requestors and/or requestor computing devices with one or more transportation providers and/or transportation provider devices. For example, a dynamic transportation matching system may match a transportation requestor to a transportation provider that operates within a dynamic transportation network.

In some examples, available sources of transportation within a dynamic transportation network may include vehicles that are owned by an owner and/or operator of the dynamic transportation matching system. Additionally or alternatively, sources of transportation within a dynamic transportation network may include vehicles that are owned outside of the dynamic transportation network but that voluntarily participate within the dynamic transportation network. In some examples, the dynamic transportation network may include road-going vehicles (e.g., cars, light trucks, etc.). Furthermore, the dynamic transportation network may include personal mobility vehicles (e.g., bikes, scooters, skateboards, etc.). In some embodiments, a dynamic transportation network may include autonomous vehicles (e.g., self-driving cars) that may be capable of operating with little or no input from a human operator.

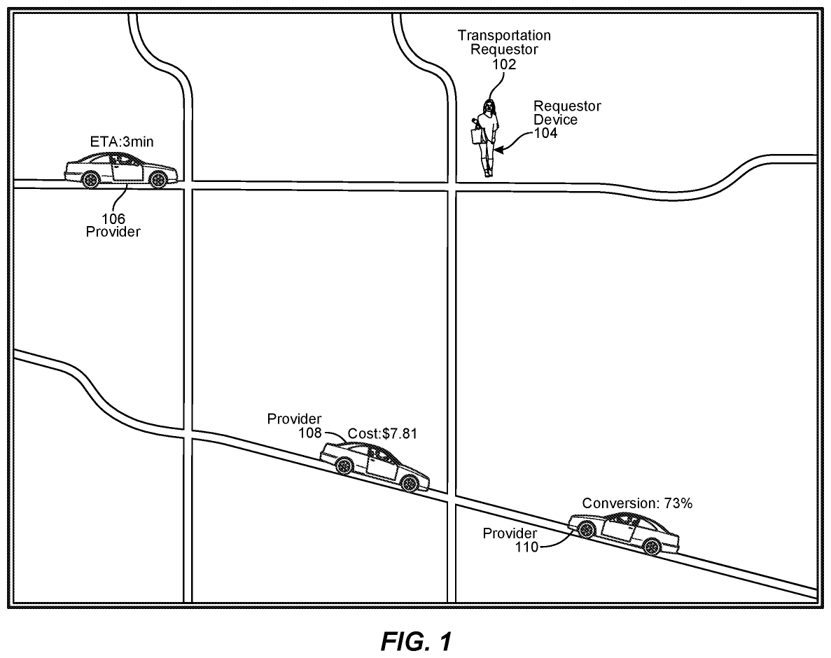

FIG. 1 illustrates an example scenario involving a transportation requestor and multiple possible transportation providers. In some examples, a transportation requestor 102 may request transportation via a requestor device 104. In one example, the underlying dynamic transportation network may consider different providers for the requestor's transportation request. For instance, the dynamic transportation network may calculate an ETA of three minutes for provider 106. The dynamic transportation network may also calculate a cost of $7.81 for provider 108. Still further, the dynamic transportation network may calculate a conversion percentage of 73% for provider 110. Accordingly, the dynamic transportation network may look at individual factors for each potential transportation provider, but may have no way of unifying these factors to determine which transportation provider, in this situation, would provide the highest overall expected value. Thus, in the embodiments described herein, a normalizing function may be used to evaluate the expected value metric for each pairing between provider and requestor. Then, the dynamic transportation network may match a transportation provider computing device with a transportation requestor computing device/requestor pairing that provides the highest expected value based on a combination of different factors.

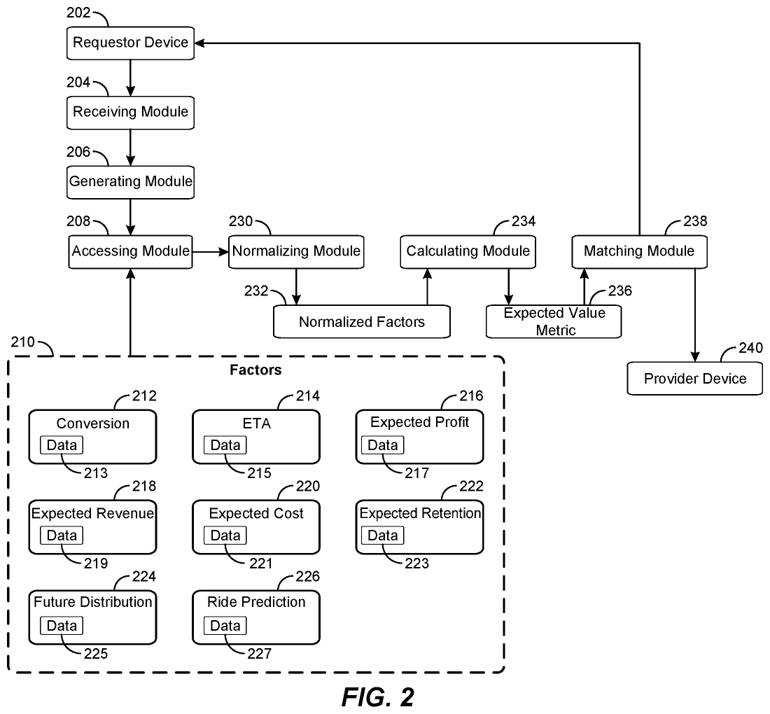

FIG. 2 illustrates an example architecture for matching requestors and providers based on one or more transportation factors 210. In one embodiment, requestor device 202 may send a request for transportation options to a receiving module 204 of a dynamic transportation network. The request for transportation options may be for any type of transportation, such as point-to-point rides in a transportation provider's privately owned car, shared rides that are shared among transportation requestors, rides that involve some portion of walking, transportation options that includes scooters, bikes, or combinations thereof, transportation options that include subways, trains, buses, meet-and-swap rides, etc. Thus, while point-to-point rides in a private car may be referred to frequently herein, it will be understood that the principles described herein may apply to any other type of transportation option.

Once the receiving module 204 receives the request for transportation options, the generating module 206 may generate one or more transportation options of various types to transport the requestor from their current location to a chosen destination. The accessing module 208 may then access data associated with various factors. For example, in order to determine a conversion factor 212, one or more portions of data 213 associated with the conversion factor may be analyzed. The data 213 may indicate information about the requestor's location, such as street information, traffic data indicating current traffic conditions, road construction or lane closure information, or similar data. The data 213 may also indicate information about the requestor, such as the number of times the requestor has cancelled trips in the past, and may further include information indicating the number of times a provider has cancelled a trip to which they previously committed. Still further, the data 213 may include information indicating the current state of the ridesharing market (e.g., pricing information). Many different types of data 213 may affect the conversion factor 212.

Similarly, the ETA factor 214 may have data 215 associated therewith indicating which available providers are in the requestor's area and an estimation of how long it would take for each provider to drive to the requestor's current location and then take them to their chosen destination. Other factors, such as expected profit 216, may have data 217 associated therewith indicating how much the generated transportation option would cost to the requestor, how much the trip would cost the provider in terms of gas, time spent, etc., and other data. Similar, but potentially different data 219, may be accessed when calculating expected revenue 218 and expected cost 220. The data 221 associated with the cost factor 220 may be more focused on the requestor but may also include data indicating an overall cost to the transportation matching system, while the data 219 associated the expected revenue factor 218 may be more focused on the provider. Data 223 associated with the expected retention factor 222 may indicate how likely the requestor and provider are to make or accept a subsequent transportation request. For instance, data 223 may indicate that requestors picked up within five minutes of their request are more likely to request again at a later time, while requestors picked up after 8 or more minutes are less likely to request a ride again. Similarly, if a provider routinely experiences cancellations, the provider may become frustrated and may stop participating as a provider. Still further, if a requestor is required to walk a lengthy distance to meet the provider, or is required to walk a lengthy distance to a subway station or to a bus stop, the requestor may be disinclined to make future requests in the transportation network. Thus, the expected retention factor 212 may indicate the likelihood that a given match between provider and requestor will increase or decrease retention of the provider and/or requestor.

Data 225 associated with future provider distribution 224 may indicate how the provider vehicles will be distributed on a map once the ride is complete. For a dynamic transportation network to function in an optimal manner, a certain number of vehicles (or other transportation means) are dispersed in each location on the map. Some map areas require fewer providers, while other map areas demand a higher number of providers. Thus, data 225 associated with the future distribution factor 224 may indicate whether a given match between a provider and a requestor will positively impact the future distribution of providers (e.g., by increasing match efficiency, reducing requestor wait times, etc.) or will negatively impact that distribution (e.g., by reducing match efficiency, increasing wait times, reducing driver retention, etc.). Data 227 related to the ride prediction factor 226 may indicate (e.g., from historical ridesharing data) when and where requestors are likely to request rides. For example, data 227 may indicate that a football game is to take place at a given stadium with a certain start time. Data 227 may indicate that approximately 3-4 hours after the start of the game, a large number of providers will be needed at the stadium to take requestors home or to other destinations. Thus, using this data 227, the ride prediction factor 226 may indicate where providers are likely to be needed and when those rides will be needed. Here, it may be recognized that the list of factors 210 used in creating an overall expected value metric 236 for a match between a requestor and a provider is exemplary in nature and is not intended to be an extensive list of all factors that may be used in generating an expected value metric. Moreover, the types of data associated with each factor may change or may overlap with other factors, or new data may be received that supplants older data. Thus, the underlying data and the various factors may be viewed as changeable and changing, perhaps even while the calculation of expected value metric 236 is being performed.

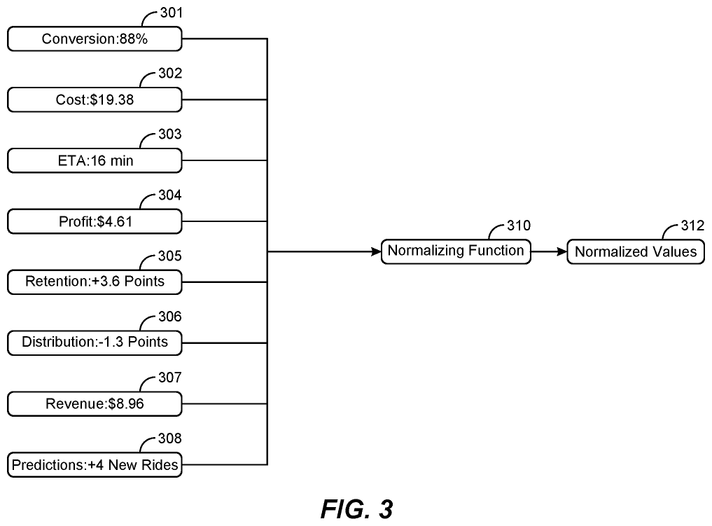

At least in some embodiments, once the accessing module 208 has accessed one or more portions of data associated with those factors that are to be used to identify an expected value metric 236, the normalizing module 230 may normalize these factors producing normalized factors 232. The normalized factors may then be used by the calculating module 234 to calculate the expected value metric 236. In some cases, only a single factor is used, while in other cases, many factors may be used when calculating the expected value metric. In cases where a single factor is used, the process of normalizing may be omitted. In cases where multiple factors are used, and where at least some of the factors are incommensurable, those factors may be normalized before being used in the expected value metric calculation. Using the expected value metric 236, the matching module 238 may then match a selected provider device 240 with the requestor device 202. The normalizing process performed by normalizing module 230 will be explained further below with regard to FIG. 3.

FIG. 3 illustrates an example architecture in which various factors that are represented in different measurement units are normalized into normalized values 312 using a normalizing function 310. The normalizing function 310 may receive any of factors 301-308 as input values or may receive different factors not shown. The normalizing function 310 may receive, for example, a conversion percentage value 301 of 88% and may normalize that percentage to a normalized value 312 of 9.1 on a scale of 1-10. While a scale of discrete numbers (e.g., 1-10) may be implemented as one example of a normalized value, it will be understood that the normalizing function may normalize the input values to substantially any common value type or any means of representing similar values, such as percentages, fractions, imaginary numbers, vectors, plot coordinates, or other systems of arranging and comparing values. Accordingly, in this example, the conversion factor indicating an 88% chance that the recommended trip will be completed may translate to, or be normalized to, a value of 9.1 on a scale of 1-10. Thus, the expected value metric (solely based on the conversion factor 301) would be 9.1. As noted above, other factors may also be considered when generating an expected value metric for a transportation option.

For example, the normalizing module 230 of FIG. 2 may further consider a cost factor 302. The cost factor 302 may indicate, in the example of FIG. 3, that the cost of a proposed ride or other transportation option is $19.38. In some embodiments, depending on when and where the ride is to take place, this amount of money may translate to a relatively low expected value. As such, the expected value metric calculated for the ride (based solely on the cost factor 302) may be 7.3. If the cost and conversion factors are considered together without any weighting, they may be averaged together for an expected value metric of 8.2. Thus, for a given transportation option, the conversion factor (expressed in percentages) and the cost factor (expressed in dollars or other currency) may both be normalized, combined, and averaged to calculate the expected value metric for a ride (8.2 in this case). In some embodiments, the cost factor 302 may refer to the expected cost of a single outcome or plan. The expected cost may consider the probability that a given requestor/provider match will complete after the request has been made. The expected cost of the plan may also consider the expected amount the provider will be paid if the match completes (potentially taking into consideration whether other requests in a route have cancelled), along with the amount that each requestor actually pays, along with the value of the match to the transportation provider network. In such embodiments, some or all of these amounts may be part of the cost factor 302 indicating the cost of a single plan.

As can be seen in FIG. 3, many more factors may be considered for a given ride. Indeed, any one or more of a plurality of transportation factors including and in addition to the factors 301-308 may be normalized and compared to find an expected value metric for each proposed ride. An ETA factor 303 of 16 minutes may be relatively good in a remote location and, as such, may be normalized to a relatively high normalized value, whereas an ETA factor of 16 minutes in a big city may be normalized to a low normalized value, indicating that the expected value provided by that ride would be low. The data associated with each factor (e.g., 213 of FIG. 2) may indicate whether the factor is good or bad based on the location of the requestor, the location of the provider, the current time of day, current transportation market conditions, likelihood of the provider accepting the transportation request, likelihood of the requestor cancelling the transportation request, and other considerations. This may allow the normalizing function 310 to generate normalized values 312 that are representative of the previous measurement unit within the normalized values that are compared against each other. Normalizing may also ensure that no single factor overbears or overrules the other factors. For instance, normalizing may convert the factors into units that are comparable with each other. During this conversion, units may be monitored and weighted to ensure that each factor is properly represented in a given requestor/provider match.

Other factors may be represented in currency such as profit factor 304, and revenue factor 307. Still other factors may be indicated in points or other measurements such as retention factor 305 (indicating that if the requestor/provider match is chosen, the requestor and/or provider retention may increase by 3.6 points), a future distribution factor 306 (indicating that if the requestor/provider match is chosen, the overall future distribution of providers will be less desirable and will decrease by 1.3 points). The prediction factor 308 may indicate that, if the requestor/provider match is chosen to go to a certain location, a certain number of new rides will likely be requested near that location. In such cases, the prediction factor would indicate that the expected value metric for the trip should be increased.

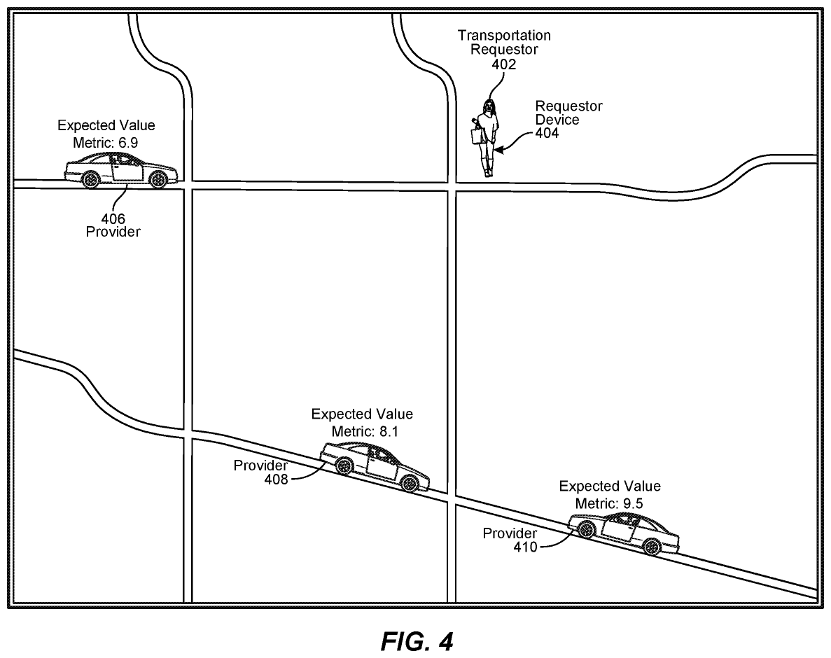

FIG. 4 illustrates an environment similar to that of FIG. 1, with a transportation requestor 402 using requestor device 404 to request transportation from their current location to a specified destination. Instead of evaluating each available provider based on a single, different factor (e.g., ETA, cost, or conversion percentage), each available provider is compared using an expected value metric calculated specifically for that requestor/provider match. Thus, the match between provider 406 and the requestor device 404 has an expected value metric of 6.9, the match between provider 408 and the requestor device 404 has an expected value metric of 8.1, and the match between provider 410 and the requestor device 404 has an expected value metric of 9.5. As such, in FIG. 4, each of the requestor/provider matches has a different value within the same common value type (e.g., expected value). In the embodiment of FIG. 4, the dynamic transportation network would likely select provider 410 to transport the requestor 402 to their destination, as provider 410 had the highest calculated expected value metric for that particular requestor/provider match at that particular time.

In some embodiments, the normalized factors may be weighted in some manner. For example, for different requestors or for different providers, the various factors (e.g., 210 of FIG. 2) may have be weighted differently depending on the request or the provider. For instance, lowest cost may be more important to one requestor than it is to another, or ETA may be more important to one requestor than it is to another. Still further, the dynamic transportation network may more heavily weight requestor or provider retention or on future provider distribution within an area. Any or all of the factors may be evaluated when determining an expected value metric may be weighted with either increased or decreased weight within the common value type.

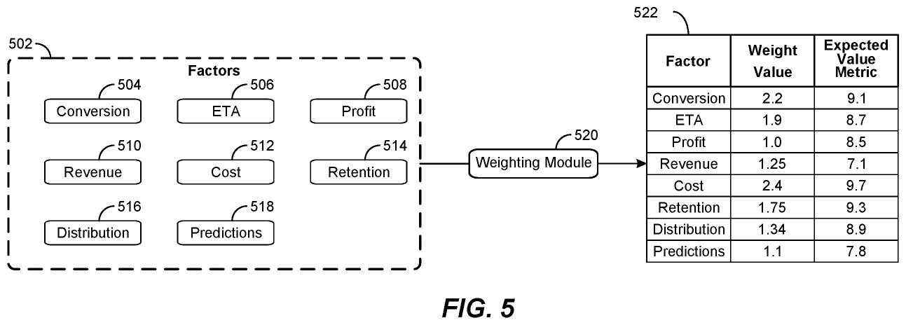

Accordingly, as shown in FIG. 5, each factor may have an assigned weight value. In FIG. 5, the factors 502 have already been normalized using the normalizing function and, as such, the expected value metric in chart 522 is shown as a discrete number between 1-10 (although as noted above, the factors may be normalized into substantially any common value type). Each of the factors 502 may be represented in chart 522, including conversion factor 504, ETA 506, expected profit 508, expected revenue 510, cost 512, retention 514, future distribution 516, and future predictions 518. The weighting module 520 (which may be part of the dynamic transportation network) may assign weight values to any or all of the factors 502. As can be seen in the chart 522, the conversion factor 504 has been assigned a relatively high weight value of 2.2, resulting in an adjusted expected value metric for the conversion factor of 9.1.In some cases, other factors such as retention 514 may have a slightly lower weight value (e.g., 1.75) but may end up with an overall higher calculated expected value metric (e.g., 9.3). This may be the result of data associated with the retention factor indicating that if a given requestor/provider match is made, the likelihood of retaining the requestor and/or the provider is high. Thus, data associated with the factor may influence the overall expected value metric, as well as the assigned weighting to that factor. Accordingly, assigned weights may place an increased or decreased importance on certain factors when determining an expected value metric.

In some cases, the dynamic transportation network may control how the weights are assigned to each factor. In other cases, each requestor computing device may be able to set its own weights for some or all of the various factors. Additionally or alternatively, the transportation provider may be able to set its own weights for the various factors. Thus, at least in some embodiments, transportation requestors and providers may be able to have at least some say over how the expected value metric for a requestor/provider match is calculated, placing an increased or decreased importance on factors that matter to them.

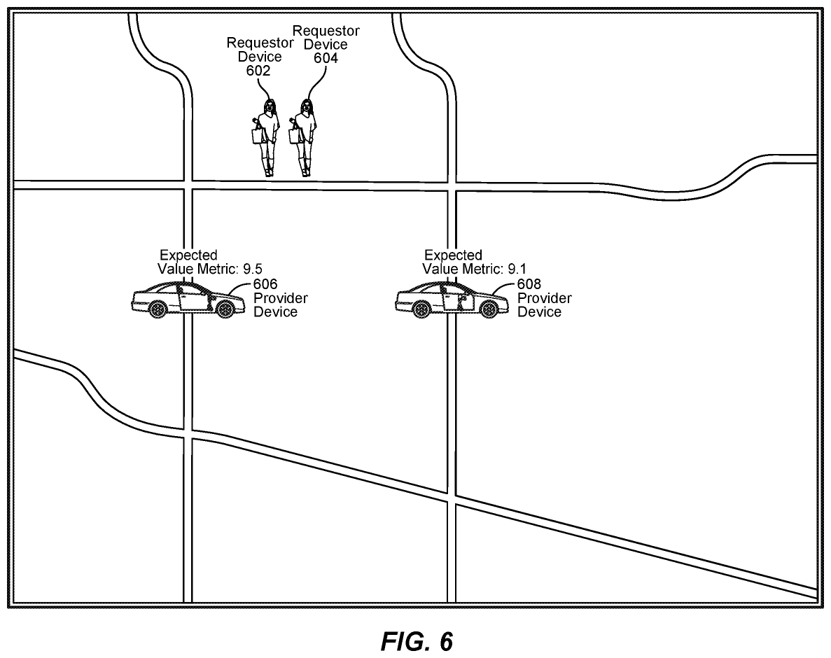

Allowing each requestor or provider to specify their own weighting factors may result in two requestors at the same location or two providers at the same location receiving different requestor/provider matches. For example, as shown in FIG. 6, a requestor device 602 and a requestor device 604 may request transportation options at substantially the same time to a similar destination. Even if provider devices 606 and 608 are both relatively close (even equidistant) to the requestors, the requestors may receive different requestor/provider matches based on their own personal weighting preferences or based on the providers' weighting preferences. Thus, for instance, provider device 606 may have a calculated expected value metric of 9.5 and provider device 608 may have a calculated expected value metric of 9.1. Traditional systems that simply look at ETA or cost are not able to look at multiple factors and user preferences and provide a dynamic matching system that truly provides the best outcome for each party in the network. For example, some requestors may prefer a shorter provider ETA, other riders may prefer a lower price. The embodiments herein may weight these preferences and provide each requestor with a tailored experience where the former requestor will wait less, but have a more expensive ride, while the latter requestor will likely wait longer, but will have a cheaper ride. As such, each requestor may receive their preferred outcome.

As noted above, many of the factors used when determining an overall expected value metric for a transportation match may have its own subfactors. For instance, as shown in FIG. 7, the transportation conversion factor 702 may have its own subfactors 704. As indicated previously, the transportation conversion factor 702 may indicate a likelihood that a requestor device and a transportation provider will each accept and complete the requested transportation option. The conversion factor 702 may be important within a dynamic transportation network as it indicates whether trips are actually being completed and not just planned. Sometimes requestors or providers may need to cancel the trip for various reasons. Completed trips, however, are often an accurate gauge for the overall success of the dynamic transportation network at providing desirable requestor/provider matches. Determining whether a generated transportation option will be carried to completion, however, is often complicated and is influenced by many different subfactors.

For example, as shown in FIG. 7, many different subfactors may play into a requestor or provider's decision to complete a trip. For instance, the number of drivers 706 or other transportation providers on the road may provide insight as to whether a requestor or provider will complete a trip. If there are not enough providers and the requestor has to wait for an overly long amount of time (e.g., over 7-10 minutes), then the likelihood of the requestor cancelling the trip goes up and the conversion factor 702 goes down. If a given requestor or provider is prone to cancelling, the number of cancellations 708 by that requestor or provider may provide an indication of the likelihood of that requestor or provider cancelling the currently matched trip. In many instances, a very small percentage of the requestors or providers in a given transportation network will provide the majority of the cancellations. Thus, identifying the requestor or provider and identifying their past cancellations 708 may provide a strong indication of whether they will cancel the current trip. In this analysis, other historical information 710, such as the number of successful trips completed, the number of tips given, the amount of time waited by the requestor for past rides, the number of shared trips taken, or other historical data may be accessed to further determine whether the user is likely to cancel or complete the current trip.

Still further, the transportation conversion factor 702 may consider metrics associated with the current ridesharing market 712. For instance, the transportation conversion factor may look at current traffic conditions (e.g., whether rush hour is currently underway), or nearby venue events (e.g., whether a concert or sporting event just ended or is about to start). The transportation conversion factor 702 may also look at whether there are enough providers in the area currently to meet demand, what the current pricing is on the dynamic transportation network or on other dynamic transportation networks, traffic conditions, road closures, subway or bus delays, or other indications of the current ridesharing market 712. Moreover, the transportation conversion factor 702 may look at current location information 714 for the requestor or provider, may look at the amount of distance the requestor would need to walk to meet up with the provider, or may consider destination information 716, such as the type of neighborhood, the amount of traffic, the type of roads available (e.g., toll roads, one-way streets, etc.), the amount of distance the requestor would need to walk after being dropped off by the provider, demographics for the current location or for the destination location, or other information associated with the current location 714 or with the requested destination 716. Accordingly, any or all of these subfactors or additional subfactors may be considered when determining the conversion factor 702. Similarly, each factor may have its own subfactors and associated data that are used to generate a comprehensive and representative factor that can subsequently be used to determine an expected value metric for a requested trip.

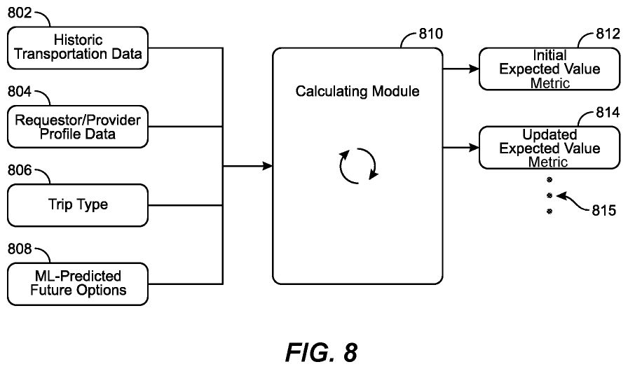

In some embodiments, even after an expected value metric has been calculated, the expected value metric may be updated based on new or changed information. For example, as shown in FIG. 8, the calculating module 810 may calculate an initial expected value metric 812 for a generated transportation option based on data associated with the normalized factors used in the calculation. However, the calculating module 810 may receive updated historical information (e.g., from microseconds in the past, days in the past, years in the past, etc.) and may alter the initial expected value metric 812 to create an updated expected value metric 814. This altering may continue repeatedly for each requestor/provider match, such that the calculating module 810 is continually producing the optimal requestor/provider match (as indicated by ellipses 815). Accordingly, the updated expected value metric 814 may be based on and may reflect historical transportation data 802 including (recently) past dynamic transportation network conditions.

Similarly, the calculating module 810 may recalculate the expected value metric for a requestor/provider match based on newly received transportation requestor or transportation provider profile data 804 associated with transportation requestors or transportation providers in the dynamic transportation network. This transportation requestor or provider profile data 804 may indicate recent cancellations, may indicate recent successfully completed trips, or may indicate preferences associated with the requestor or the provider. Thus, the calculating module 810 may change the initial expected value metric 812 and assign it a new value. Still further, if the requestor's trip type 806 changes from a single ride to a shared ride, from a shared ride to a luxury ride, from a single ride to a swap ride where riders get out of the initial car and into another car, or from a private ride to a ride that combines one or more public transportation options, the calculating module 810 may alter the initial expected value metric 812 based on the new information.

Machine learning models may also be used to predict future transportation options 808, which may then be used by the calculating module 810 to alter the initial expected value metric 812. In some embodiments, the dynamic transportation network may be configured to instantiate one or more machine learning algorithms on at least one of the computing systems described herein. The machine learning algorithms may be implemented to predict future transportation option outcomes based on current dynamic transportation network conditions. Thus, for example, a machine learning algorithm may predict that rides will be needed in a certain area, or may predict that certain rides will cancel, or may predict that new providers will become available at a certain time. Any or all of these (or other) machine learning-predicted future transportation options 808 may be implemented by the calculating module 810 in updating the expected value metric calculation.

The calculating module 810 may also be configured to analyze tradeoffs associated with the calculated expected value metric 812. For example, by matching one requestor to a given provider, that provider may no longer be able to provide rides to other requestors. Many such tradeoffs including benefits or drawbacks to certain parties in the dynamic transportation network may be evaluated and considered when generating an initial expected value metric 812 and when generating updated expected value metrics. Along these lines, the calculating module 810 may also analyze specified indirect costs associated with the expected value metrics, such as potential insurance increases, potential added costs to providers for gas or wear on the vehicle, or the cost of losing a requestor or provider from the network. The calculating module 810 may be configured to look at large volumes of data from a wide variety of sources to determine a level of impact on the dynamic transportation network for any given decision. Each requestor/provider match may have benefits and drawbacks, as well as indirect costs and consequences. These may also be considered by the calculating module 810 when computing an initial or updated expected value metric. By calculating an expected value metric for each requestor/provider match and by matching requestors and providers according to the expected value metric, requestor and provider computing devices may take less time to perform the initial match, may take less time to reach each other to provide the transportation, may be more efficiently matched by location, transportation time, current traffic and market conditions, and may be more quickly dispatched. These efficiencies reduce computing overhead (e.g., CPU usage, memory usage, data storage) on the provider computing device, on the requestor computing device, and on any intermediary devices. These efficiencies may also result in less wireless network usage as less data may be transmitted during the more efficient expected-value-based matching.

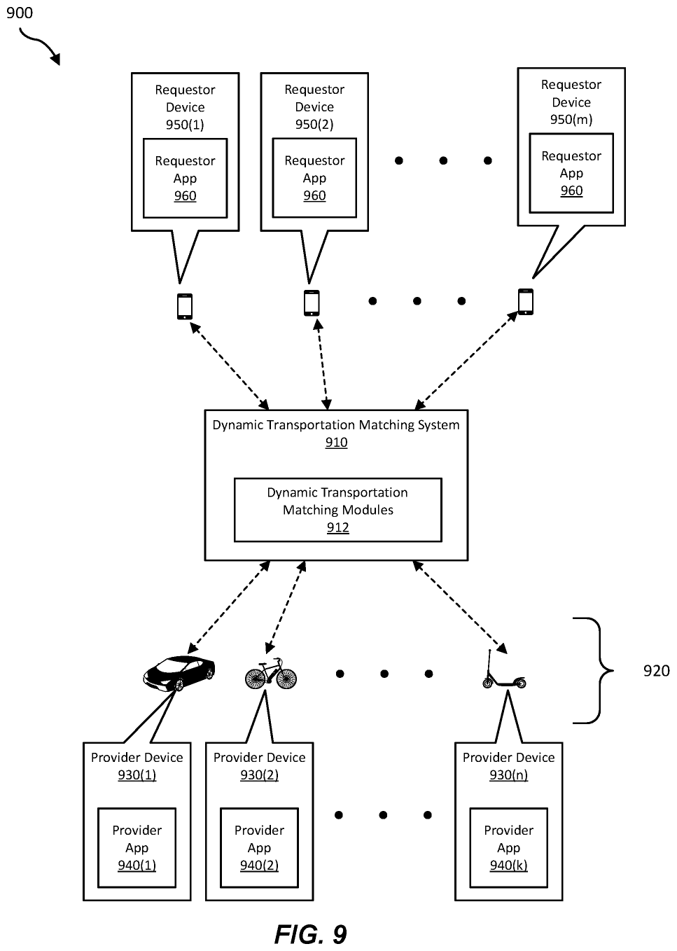

FIG. 9 illustrates an example system 900 for matching transportation requests with a dynamic transportation network that includes personal mobility vehicles. As shown in FIG. 9, a dynamic transportation matching system 910 may be configured with one or more dynamic transportation matching modules 912 that may perform one or more of the steps described herein. Dynamic transportation matching system 910 may represent any computing system and/or set of computing systems capable of matching transportation requests. Dynamic transportation matching system 910 may be in communication with computing devices in each of a group of vehicles 920. Vehicles 920 may represent any vehicles that may fulfill transportation requests. In some examples, vehicles 920 may include disparate vehicle types and/or models. For example, vehicles 920 may include road-going vehicles and personal mobility vehicles. In some examples, some of vehicles 920 may be standard commercially available vehicles. According to some examples, some of vehicles 920 may be owned by separate individuals (e.g., transportation providers). Furthermore, while, in some examples, many or all of vehicles 920 may be human-operated, in some examples many of vehicles 920 may also be autonomous (or partly autonomous). Accordingly, throughout the instant disclosure, references to a “transportation provider” (or “provider”) may, where appropriate, refer to an operator of a human driven vehicle, an autonomous vehicle control system, an autonomous vehicle, an owner of an autonomous vehicle, an operator of an autonomous vehicle, an attendant of an autonomous vehicle, a vehicle piloted by a requestor, and/or an autonomous system for piloting a vehicle. While FIG. 9 does not specify the number of vehicles 920, it may be readily appreciated that the systems described herein are applicable to hundreds of vehicles, thousands of vehicles, or more. In one example, dynamic transportation matching system 910 may coordinate transportation matchings within a single region for 50,000 vehicles or more on a given day. In some examples, vehicles 920 may collectively form a dynamic transportation network that may provide transportation supply on an on-demand basis to transportation requestors.

As mentioned above, dynamic transportation matching system 910 may communicate with computing devices in each of vehicles 920. The computing devices may be any suitable type of computing device. In some examples, one or more of the computing devices may be integrated into the respective vehicles 920. In some examples, one or more of the computing devices may be mobile devices. For example, one or more of the computing devices may be smartphones. Additionally or alternatively, one or more of the computing devices may be tablet computers, personal digital assistants, or any other type or form of mobile computing device. According to some examples, one or more of the computing devices may include wearable computing devices (e.g., a driver-wearable computing device), such as smart glasses, smart watches, etc. In some examples, one or more of the computing devices may be devices suitable for temporarily mounting in a vehicle (e.g., for use by a requestor and/or provider for a transportation matching application, a navigation application, and/or any other application suited for the use of requestors and/or providers). Additionally or alternatively, one or more of the computing devices may be devices suitable for installing in a vehicle and/or may be a vehicle's computer that has a transportation management system application installed on the computer in order to provide transportation services to transportation requestors and/or communicate with dynamic transportation matching system 910.

As shown in FIG. 9, vehicles 920 may include provider devices 930(1)-(n) (e.g., whether integrated into the vehicle, permanently affixed to the vehicle, temporarily affixed to the vehicle, worn by a driver of the vehicle, etc.). In some examples, provider devices 930 may include a provider apps 940(1)-(k). Provider apps 940(1)-(k) may represent any application, program, and/or module that may provide one or more services related to operating a vehicle and/or providing transportation matching services. For example, provider apps 940(1)-(k) may include a transportation matching application for providers and/or one or more applications for matching personal mobility vehicles (PMVs) with requestor devices. In some embodiments, different types of provider vehicles may be provisioned with different types of provider devices and/or different provider applications. For example, PMVs may be provisioned with provider devices that are configured with a provider application that enables transportation requestors to reserve and/or operate the PMV while road-constrained vehicles (e.g., cars) may be provisioned with provider devices that are configured with a provider application that enables provider vehicle operators (e.g., transportation providers) to respond to requests from transportation requestors. In some examples, provider applications 940(1)-(k) may match the user of provider apps 940(1)-(k) (e.g., a transportation provider) with transportation requestors through communication with dynamic transportation matching system 910. In addition, and as is described in greater detail below, provider apps 940(1)-(k) may provide dynamic transportation management system 910 with information about a provider (including, e.g., the current location of the provider and/or vehicle) to enable dynamic transportation management system 910 to provide dynamic transportation matching and/or management services for the provider and one or more requestors. In some examples, provider apps 940(1)-(k) may coordinate communications and/or a payment between a requestor and a provider. According to some embodiments, provider apps 940(1)-(k) may provide a map service, a navigation service, a traffic notification service, and/or a geolocation service.

Additionally, as shown in FIG. 9, dynamic transportation matching system 910 may communicate with requestor devices 950(1)-(m). In some examples, requestor devices 950 may include a requestor app 960. Requestor app 960 may represent any application, program, and/or module that may provide one or more services related to requesting transportation matching services. For example, requestor app 960 may include a transportation matching application for requestors. In some examples, requestor app 960 may match the user of requestor app 960 (e.g., a transportation requestor) with transportation providers through communication with dynamic transportation matching system 910. In addition, and as is described in greater detail below, requestor app 960 may provide dynamic transportation management system 910 with information about a requestor (including, e.g., the current location of the requestor) to enable dynamic transportation management system 910 to provide dynamic transportation matching services for the requestor and one or more providers. In some examples, requestor app 960 may coordinate communications and/or a payment between a requestor and a provider. According to some embodiments, requestor app 960 may provide a map service, a navigation service, a traffic notification service, and/or a geolocation service.

Embodiments of the instant disclosure may include or be implemented in conjunction with a dynamic transportation matching system. A transportation matching system may arrange transportation on an on-demand and/or ad-hoc basis by, e.g., matching one or more transportation requestors with one or more transportation providers. For example, a transportation matching system may provide one or more transportation matching services for a networked transportation service, a ridesourcing service, a taxicab service, a car-booking service, an autonomous vehicle service, a personal mobility vehicle service, or some combination and/or derivative thereof. The transportation matching system may include and/or interface with any of a variety of subsystems that may implement, support, and/or improve a transportation matching service. For example, the transportation matching system may include a matching system (e.g., that matches requestors to ride opportunities and/or that arranges for requestors and/or providers to meet), a mapping system, a navigation system (e.g., to help a provider reach a requestor, to help a requestor reach a provider, and/or to help a provider reach a destination), a reputation system (e.g., to rate and/or gauge the trustworthiness of a requestor and/or a provider), a payment system, and/or an autonomous or semi-autonomous driving system. The transportation matching system may be implemented on various platforms, such as a requestor-owned mobile device, a computing system installed in a vehicle, a requestor-owned mobile device, a server computer system, or any other hardware platform capable of providing transportation matching services to one or more requestors and/or providers.

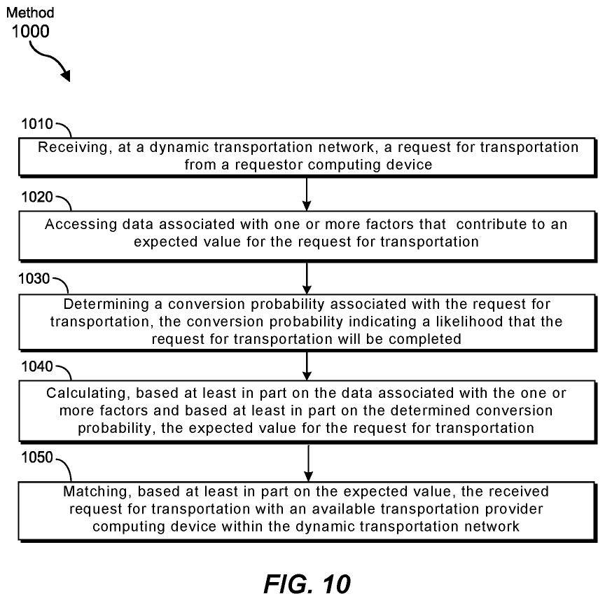

FIG. 10 illustrates an example method 1000 for matching transportation requestors and providers using an expected value metric. As illustrated in FIG. 10, at step 1010, one or more of the systems described herein may receive, at a dynamic transportation network, a request for transportation from a requestor computing device.

At step 1020, one or more of the systems described herein may access data associated with one or more factors that contribute to an expected value metric for the request for transportation.

At step 1030, one or more of the systems described herein may determine a conversion probability associated with the request for transportation, where the conversion probability indicates a likelihood that the request for transportation will be completed.

In some examples, the one or more factors may include at least two factors, and the at least two factors may be at least initially incommensurable with each other. In some examples, the method may further include normalizing the at least two incommensurable factors using a normalizing function, such that upon completion of the normalizing function, the at least two normalized factors are commensurable with each other.

In some examples, the normalizing may further include weighting the one or more factors within the common value type, such that each factor has an assigned weight value. The assigned weight values for each factor may be different for different requestor computing devices, allowing each requestor computing device to have its own weighting of factors affecting the expected value metric. In some examples, the weighting values associated with the factors may be configurable for transportation requestors on each requestor computing device.

In some examples, at least one of the one or more factors may be a transportation conversion factor. The transportation conversion factor may indicate a likelihood that the requestor device and the transportation provider will each accept and complete the requested transportation option.

In some examples, at least one of the one or more factors may be an expected revenue factor. The expected revenue factor may indicate an amount of revenue that would be realized if the requestor device were to be matched with the transportation provider device. In some examples, at least one of the one or more factors may be an estimated time of arrival (ETA) factor. The ETA factor may indicate an amount of time that is expected to pass before the transportation provider device arrives at the requestor computing device.

In some examples, at least one of the one or more factors may include a cost to the requestor computing device. The cost factor may indicate an amount of cost to the requestor computing device if the requestor computing device were to be matched with the transportation provider device.

In some examples, at least one of the one or more factors may include an expected profit factor. The expected profit factor may indicate an amount of profit that would be realized if the requestor computing device were to be matched with the transportation provider device.

At step 1040, one or more of the systems described herein may calculate, based at least in part on the data associated with the one or more factors and based at least in part on the determined conversion probability, the expected value metric for the request for transportation.

In some examples, a calculating module may calculate the expected value metric for the requested transportation based on the data associated with the one or more factors by: accessing one or more portions of historical transportation data generated based on transport options generated within the dynamic transportation network and altering the calculation according to the accessed historical transportation data, such that the calculated expected value metric reflects dynamic transportation network conditions reflected by the historical transportation data.

In some examples, the calculating module may calculate the expected value metric for the requested transportation based on the data associated with the one or more factors by: accessing one or more portions of requestor computing device or transportation provider device profile data associated with requestor computing devices or transportation provider devices in the dynamic transportation network and altering the calculation according to the accessed requestor computing device or transportation provider device profile data, such that the calculated expected value metric reflects requestor computing device or transportation provider device preferences reflected by the requestor computing device or transportation provider device profile data.

In some examples, the calculating module may calculate the expected value metric for the requested transportation based on the data associated with the one or more factors by: accessing a trip type indicated in the received request for transportation and altering the calculation according to the accessed trip type, such that the calculated expected value metric is specific to the trip type indicated in the received request for transportation.

In some examples, the calculating module may calculate the expected value metric for the requested transportation based on the data associated with the one or more factors by: instantiating at least one machine learning algorithm, implementing the at least one machine learning algorithm to predict one or more future transportation outcomes based on current dynamic transportation network conditions, and altering the calculation according to the one or more predicted future transportation outcomes.

In some examples, the calculating module may analyze tradeoffs associated with the calculated expected value metric, including analyzing specified benefits and drawbacks to specified parties in the dynamic transportation network. In some examples, the calculating module may analyze specified indirect costs associated with the calculated expected value metric for at least one of the requested transportation. In some examples, the calculating module may determine a level of impact on the dynamic transportation network predicted to result from the requested transportation.

At step 1050, one or more systems described herein may match, based at least in part on the expected value metric, the received request for transportation with an available transportation provider computing device within the dynamic transportation network.

While various examples provided herein relate to transportation, embodiments of the instant disclosure may include or be implemented in conjunction with a dynamic matching system applied to one or more services instead of and/or in addition to transportation services. For example, embodiments described herein may be used to match service providers with service requestors for any service.

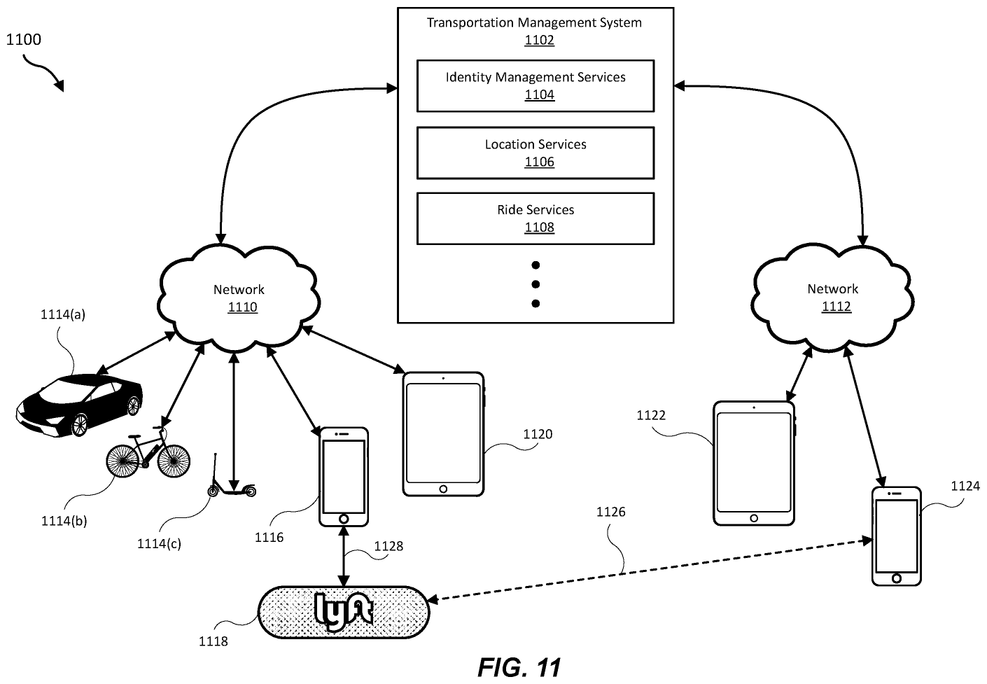

FIG. 11 shows a transportation management environment 1100, in accordance with various embodiments. As shown in FIG. 11, a transportation management system 1102 may run one or more services and/or software applications, such as identity management services 1104, location services 1106, ride services 1108, and/or other services. Although FIG. 11 shows a certain number of services provided by transportation management system 1102, more or fewer services may be provided in various implementations. In addition, although FIG. 11 shows these services as being provided by transportation management system 1102, all or a portion of any of the services may be processed in a distributed fashion. For example, computations associated with a service task may be performed by a combination of transportation management system 1102 (including any number of servers, databases, etc.), one or more devices associated with a provider (e.g., devices integrated with managed vehicles 1114(a), 1114(b), and/or 1114(c); provider computing devices 1116 and tablets 1120; and transportation management vehicle devices 1118), and/or more or more devices associated with a ride requestor (e.g., the requestor's computing devices 1124 and tablets 1122). In some embodiments, transportation management system 1102 may include one or more general purpose computers, server computers, clustered computing systems, cloud-based computing systems, and/or any other computing systems or arrangements of computing systems. Transportation management system 1102 may be configured to run any or all of the services and/or software components described herein. In some embodiments, the transportation management system 1102 may include an appropriate operating system and/or various server applications, such as web servers capable of handling hypertext transport protocol (HTTP) requests, file transfer protocol (FTP) servers, database servers, etc.

In some embodiments, identity management services 1104 may be configured to perform authorization services for requestors and providers and/or manage their interactions and/or data with transportation management system 1102. This may include, e.g., authenticating the identity of providers and determining that they are authorized to provide services through transportation management system 1102. Similarly, requestors' identities may be authenticated to determine whether they are authorized to receive the requested services through transportation management system 1102. Identity management services 1104 may also manage and/or control access to provider and/or requestor data maintained by transportation management system 1102, such as driving and/or ride histories, vehicle data, personal data, preferences, usage patterns as a ride provider and/or as a ride requestor, profile pictures, linked third-party accounts (e.g., credentials for music and/or entertainment services, social-networking systems, calendar systems, task-management systems, etc.) and any other associated information. Transportation management system 1102 may also manage and/or control access to provider and/or requestor data stored with and/or obtained from third-party systems. For example, a requester or provider may grant transportation management system 1102 access to a third-party email, calendar, or task management system (e.g., via the user's credentials). As another example, a requestor or provider may grant, through a mobile device (e.g., 1116, 1120, 1122, or 1124), a transportation application associated with transportation management system 1102 access to data provided by other applications installed on the mobile device. In some examples, such data may be processed on the client and/or uploaded to transportation management system 1102 for processing.

In some embodiments, transportation management system 1102 may provide ride services 1108, which may include ride matching and/or management services to connect a requestor to a provider. For example, after identity management services module 1104 has authenticated the identity a ride requestor, ride services module 1108 may attempt to match the requestor with one or more ride providers. In some embodiments, ride services module 1108 may identify an appropriate provider using location data obtained from location services module 1106. Ride services module 1108 may use the location data to identify providers who are geographically close to the requestor (e.g., within a certain threshold distance or travel time) and/or who are otherwise a good match with the requestor. Ride services module 1108 may implement matching algorithms that score providers based on, e.g., preferences of providers and requestors; vehicle features, amenities, condition, and/or status; providers' preferred general travel direction and/or route, range of travel, and/or availability; requestors' origination and destination locations, time constraints, and/or vehicle feature needs; and any other pertinent information for matching requestors with providers. In some embodiments, ride services module 1108 may use rule-based algorithms and/or machine-learning models for matching requestors and providers.

Transportation management system 1102 may communicatively connect to various devices through networks 1110 and/or 1112. Networks 1110 and 1112 may include any combination of interconnected networks configured to send and/or receive data communications using various communication protocols and transmission technologies. In some embodiments, networks 1110 and/or 1112 may include local area networks (LANs), wide-area networks (WANs), and/or the Internet, and may support communication protocols such as transmission control protocol/Internet protocol (TCP/IP), Internet packet exchange (IPX), systems network architecture (SNA), and/or any other suitable network protocols. In some embodiments, data may be transmitted through networks 1110 and/or 1112 using a mobile network (such as a mobile telephone network, cellular network, satellite network, or other mobile network), a public switched telephone network (PSTN), wired communication protocols (e.g., Universal Serial Bus (USB), Controller Area Network (CAN)), and/or wireless communication protocols (e.g., wireless LAN (WLAN) technologies implementing the IEEE 902.12 family of standards, Bluetooth, Bluetooth Low Energy, Near Field Communication (NFC), Z-Wave, and ZigBee). In various embodiments, networks 1110 and/or 1112 may include any combination of networks described herein or any other type of network capable of facilitating communication across networks 1110 and/or 1112.

In some embodiments, transportation management vehicle device 1118 may include a provider communication device configured to communicate with users, such as drivers, passengers, pedestrians, and/or other users. In some embodiments, transportation management vehicle device 1118 may communicate directly with transportation management system 1102 or through another provider computing device, such as provider computing device 1116. In some embodiments, a requestor computing device (e.g., device 1124) may communicate via a connection 1126 directly with transportation management vehicle device 1118 via a communication channel and/or connection, such as a peer-to-peer connection, Bluetooth connection, NFC connection, ad hoc wireless network, and/or any other communication channel or connection. Although FIG. 11 shows particular devices communicating with transportation management system 1102 over networks 1110 and 1112, in various embodiments, transportation management system 1102 may expose an interface, such as an application programming interface (API) or service provider interface (SPI) to enable various third parties which may serve as an intermediary between end users and transportation management system 1102.

In some embodiments, devices within a vehicle may be interconnected. For example, any combination of the following may be communicatively connected: vehicle 1114, provider computing device 1116, provider tablet 1120, transportation management vehicle device 1118, requestor computing device 1124, requestor tablet 1122, and any other device (e.g., smart watch, smart tags, etc.). For example, transportation management vehicle device 1118 may be communicatively connected to provider computing device 1116 and/or requestor computing device 1124. Transportation management vehicle device 1118 may establish communicative connections, such as connections 1126 and 1128, to those devices via any suitable communication technology, including, e.g., WLAN technologies implementing the IEEE 902.12 family of standards, Bluetooth, Bluetooth Low Energy, NFC, Z-Wave, ZigBee, and any other suitable short-range wireless communication technology.

In some embodiments, users may utilize and interface with one or more services provided by the transportation management system 1102 using applications executing on their respective computing devices (e.g., 1116, 1118, 1120, and/or a computing device integrated within vehicle 1114), which may include mobile devices (e.g., an iPhone®, an iPad®, mobile telephone, tablet computer, a personal digital assistant (PDA)), laptops, wearable devices (e.g., smart watch, smart glasses, head mounted displays, etc.), thin client devices, gaming consoles, and any other computing devices. In some embodiments, vehicle 1114 may include a vehicle-integrated computing device, such as a vehicle navigation system, or other computing device integrated with the vehicle itself, such as the management system of an autonomous vehicle. The computing device may run on any suitable operating systems, such as Android®, iOS®, macOS®, Windows®, Linux®, UNIX®, or UNIX®-based or Linux®-based operating systems, or other operating systems. The computing device may further be configured to send and receive data over the Internet, short message service (SMS), email, and various other messaging applications and/or communication protocols. In some embodiments, one or more software applications may be installed on the computing device of a provider or requestor, including an application associated with transportation management system 1102. The transportation application may, for example, be distributed by an entity associated with the transportation management system via any distribution channel, such as an online source from which applications may be downloaded. Additional third-party applications unassociated with the transportation management system may also be installed on the computing device. In some embodiments, the transportation application may communicate or share data and resources with one or more of the installed third-party applications.

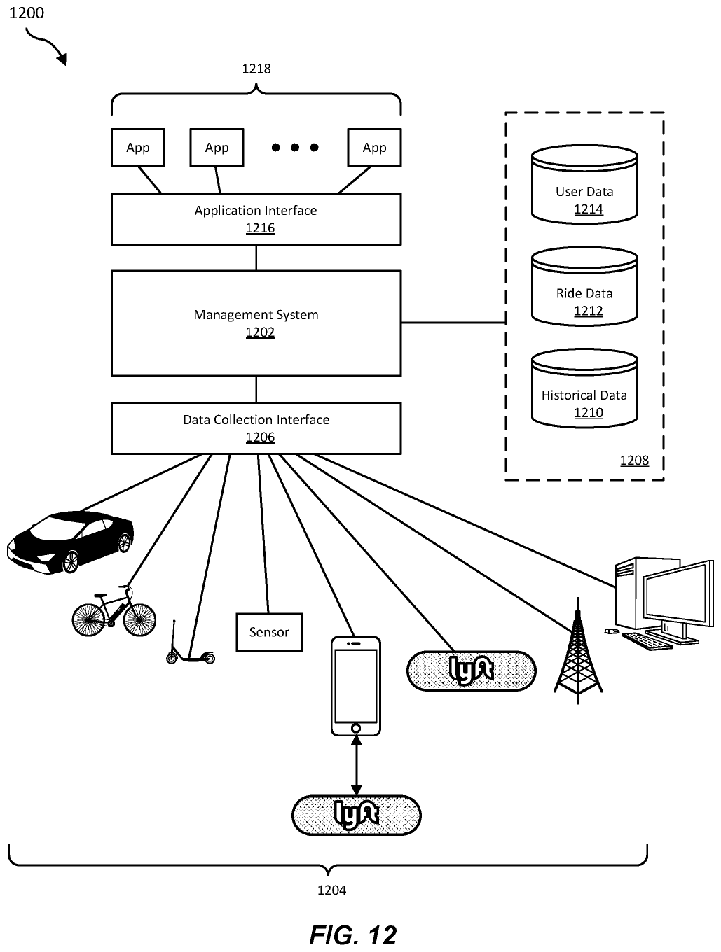

FIG. 12 shows a data collection and application management environment 1200, in accordance with various embodiments. As shown in FIG. 12, management system 1202 may be configured to collect data from various data collection devices 1204 through a data collection interface 1206. As discussed above, management system 1202 may include one or more computers and/or servers or any combination thereof. Data collection devices 1204 may include, but are not limited to, user devices (including provider and requestor computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 1206 can include, e.g., an extensible device framework configured to support interfaces for each data collection device. In various embodiments, data collection interface 1206 may be extended to support new data collection devices as they are released and/or to update existing interfaces to support changes to existing data collection devices. In various embodiments, data collection devices may communicate with data collection interface 1206 over one or more networks. The networks may include any network or communication protocol as would be recognized by one of ordinary skill in the art, including those networks discussed above.

As shown in FIG. 12, data received from data collection devices 1204 can be stored in data store 1208. Data store 1208 may include one or more data stores, such as databases, object storage systems and services, cloud-based storage services, and other data stores. For example, various data stores may be implemented on a non-transitory storage medium accessible to management system 1202, such as historical data store 1210, ride data store 1212, and user data store 1214. Data stores 1208 can be local to management system 1202, or remote and accessible over a network, such as those networks discussed above or a storage-area network or other networked storage system. In various embodiments, historical data 1210 may include historical traffic data, weather data, request data, road condition data, or any other data for a given region or regions received from various data collection devices. Ride data 1212 may include route data, request data, timing data, and other ride related data, in aggregate and/or by requestor or provider. User data 1214 may include user account data, preferences, location history, and other user-specific data. Although certain data stores are shown by way of example, any data collected and/or stored according to the various embodiments described herein may be stored in data stores 1208.

As shown in FIG. 12, an application interface 1216 can be provided by management system 1202 to enable various apps 1218 to access data and/or services available through management system 1202. Apps 1218 may run on various user devices (including provider and requestor computing devices, such as those discussed above) and/or may include cloud-based or other distributed apps configured to run across various devices (e.g., computers, servers, or combinations thereof). Apps 1218 may include, e.g., aggregation and/or reporting apps which may utilize data 1208 to provide various services (e.g., third-party ride request and management apps). In various embodiments, application interface 1216 can include an API and/or SPI enabling third party development of apps 1218. In some embodiments, application interface 1216 may include a web interface, enabling web-based access to data 1208 and/or services provided by management system 1202. In various embodiments, apps 1218 may run on devices configured to communicate with application interface 1216 over one or more networks. The networks may include any network or communication protocol as would be recognized by one of ordinary skill in the art, including those networks discussed above, in accordance with an embodiment of the present disclosure.

While various embodiments of the present disclosure are described in terms of a networked transportation system in which the ride providers are human drivers operating their own vehicles, in other embodiments, the techniques described herein may also be used in environments in which ride requests are fulfilled using autonomous or semi-autonomous vehicles. For example, a transportation management system of a networked transportation service may facilitate the fulfillment of ride requests using both human drivers and autonomous vehicles. Additionally or alternatively, without limitation to transportation services, a matching system for any service may facilitate the fulfillment of requests using both human drivers and autonomous vehicles.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
one or more memories;
one or more physical processors configured to execute instructions from the one or more memories to perform operations comprising:
receiving, at a dynamic transportation network, a request for transportation from a requestor computing device;
accessing data associated with one or more factors that contribute to an expected value metric for the request for transportation;
determining a conversion probability associated with the request for transportation, the conversion probability indicating a likelihood that the request for transportation will be completed;
calculating, based at least in part on the data associated with the one or more factors and based at least in part on the determined conversion probability, the expected value metric for the request for transportation; and
matching, based at least in part on the expected value metric, the received request for transportation with an available transportation provider computing device within the dynamic transportation network.

2. The system of claim 1 wherein the one or more factors comprise at least two factors, and wherein the at least two factors are at least initially incommensurable with each other.

3. The system of claim 2, wherein the operations further comprise normalizing the at least two incommensurable factors using a normalizing function, such that upon completion of the normalizing function, the at least two normalized factors have units of measure that are commensurable with each other.

4. The system of claim 2, wherein the operations further comprise weighting the one or more factors within a common value type such that each factor has an assigned weight value.

5. The system of claim 4, wherein the assigned weight values for each factor are distinct for different requestor computing devices such that each requestor computing device has its own weighting of factors affecting the expected value metric.

6. The system of claim 5, wherein the assigned weight values associated with the one or more factors are configurable for requestors on each requestor computing device.

7. The system of claim 1, wherein at least one of the one or more factors comprises a transportation conversion factor, the transportation conversion factor indicating at least one of:
a likelihood that the requestor computing device will accept a match for the requested transportation; or
a likelihood that the transportation provider device will accept a match for the requested transportation.

8. A computer-implemented method comprising:
receiving, at a dynamic transportation network, a request for transportation from a requestor computing device;
accessing data associated with one or more factors that contribute to an expected value metric for the request for transportation;
determining a conversion probability associated with the request for transportation, the conversion probability indicating a likelihood that the request for transportation will be completed;
calculating, based at least in part on the data associated with the one or more factors and based at least in part on the determined conversion probability, the expected value metric for the request for transportation; and
matching, based at least in part on the expected value metric, the received request for transportation with an available transportation provider computing device within the dynamic transportation network.

9. The computer-implemented method of claim 8, wherein the one or more factors comprise at least two factors, and wherein the at least two factors are at least initially incommensurable with each other.

10. The computer-implemented method of claim 9, further comprising normalizing the at least two incommensurable factors using a normalizing function, such that upon completion of the normalizing function, the at least two normalized factors have units of measure that are commensurable with each other.

11. The computer-implemented method of claim 9, further comprising weighting the one or more factors within a common value type such that each factor has an assigned weight value.

12. The computer-implemented method of claim 11, wherein the assigned weight values for each factor are distinct for different requestor computing devices such that each requestor computing device has its own weighting of factors affecting the expected value metric.

13. The computer-implemented method of claim 12, wherein the assigned weight values associated with the one or more factors are configurable for requestors on each requestor computing device.

14. The computer-implemented method of claim 8, wherein at least one of the one or more factors comprises a transportation conversion factor, the transportation conversion factor indicating at least one of:
a likelihood that the requestor computing device will accept a match for the requested transportation; or
a likelihood that the transportation provider device will accept a match for the requested transportation.

15. A non-transitory computer-readable medium comprising
computer-readable instructions that, when executed by at least one processor of a computing device, cause the computing device to:
receive, at a dynamic transportation network, a request for transportation from a requestor computing device;
access data associated with one or more factors that affect contribute to an expected value metric for the request for transportation;
determine a conversion probability associated with the request for transportation, the conversion probability indicating a likelihood that the request for transportation will be completed;
calculate, based at least in part on the data associated with the one or more factors and based at least in part on the determined conversion probability, the expected value metric for the request for transportation; and
match, based at least in part on the expected value metric, the received request for transportation with an available transportation provider computing device within the dynamic transportation network.

16. The non-transitory computer-readable medium of claim 15, wherein the one or more factors comprise at least two factors, and wherein the at least two factors are at least initially incommensurable with each other.

17. The non-transitory computer-readable medium of claim 16, wherein the computer-readable instructions further cause the computing device to normalize the at least two incommensurable factors using a normalizing function, such that upon completion of the normalizing function, the at least two normalized factors have units of measure that are commensurable with each other.

18. The non-transitory computer-readable medium of claim 16, wherein the computer-readable instructions further cause the computing device to weight the one or more factors within a common value type such that each factor has an assigned weight value.

19. The non-transitory computer-readable medium of claim 18, wherein the assigned weight values for each factor are distinct for different requestor computing devices such that each requestor computing device has its own weighting of factors affecting the expected value metric.

20. The non-transitory computer-readable medium of claim 19, wherein the assigned weight values associated with the one or more factors are configurable for requestors on each requestor computing device.
